(19) United States
(12) Patent Application Publication
(10) Pub. No.: US 2010/0211862 A1
(43) Pub. Date: Aug. 19, 2010

(54) FACILITATING SPREADSHEET AND DATABASE VIEWS ON COMMON DATA STORE

(75) Inventors: Dan Parish, Kirkland, WA (US); Steven Greenberg, Seattle, WA (US); Clinton Covington, Redmond, WA (US); Eran Megiddo, Bellevue, WA (US); Andrew Miller, Issaquah, WA (US); Gregory Lindhorst, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/388,353

(22) Filed: Feb. 18, 2009

(51) Int. Cl. G06F 17/00; G06F 17/30

(52) U.S. Cl. 715/212; 707/E17.014; 707/E17.044

(57) ABSTRACT

Users of spreadsheet/database web services are provided with a seamless experience of being able to interact with a single set of data both as a spreadsheet and as a database. Tables or datasheets in spreadsheet services and database services are linked with a read/write connection to a common data store. In addition to enabling the users to view the data in a companion user interface and edit employing the companion user interface's elements and operations, changes made in the data are reflected in both services through the common data store.

### BACKGROUND

Web services for widespread user applications such as word processing, presentation, calendaring, and spreadsheets are becoming increasingly common. Users no longer need to deal with disadvantages of locally installed and executed applications such as having to update or reinstall the application each time an aspect of the application or the computing device changes, being tied to a single machine for processing their documents, and similar challenges.

Spreadsheet applications enable users to process a variety of data types in ad-hoc or tabular format, compute formulas, run analyses, create charts, and so on. Database applications, on the other hand, provide data management functionality through multiple dimensions, related data tables, and comparable ones, with efficient mechanisms to query and access the data. Database and spreadsheet programs provide two complementary ways to store, analyze and interact with structured data. Traditionally, it has been hard for end users to get the benefits of both without sacrificing some functionality. In particular, either the spreadsheet or the database application must be typically limited to a read-only view.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing users a seamless experience of being able to interact with a single set of data both as a spreadsheet and as a database. Tables in spreadsheet services and database services are linked with a read/write connection to a common data store. Changes made in spreadsheet services are reflected in database services and vice versa.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example web service providing spreadsheet and database functionality, where embodiments may be implemented;

FIG. 2 is a conceptual diagram illustrating another example web service providing spreadsheet and database functionality, where embodiments may be implemented;

FIG. 3 illustrates an architecture of an example spreadsheet service;

FIG. 4 illustrates an overall architecture of a web service providing spreadsheet and database functionality with a common data store according to embodiments;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process of providing seamless spreadsheet and database views to a user from a web service according to embodiments.

### DETAILED DESCRIPTION

As discussed above, database and spreadsheet programs provide complementary ways to store, analyze, and interact with structured data resulting in loss of functionality when such programs are used in conjunction with each other. Generally loss of functionality occurs because one or the other of the programs is used as a ‘view’ on the other and because spreadsheets and databases are often viewed as separate entities and not two sides of the same data compilation. Additionally, the programs do not share a common data store, which makes the two programs working together much more difficult. With database and spreadsheet functionality both running in a server environment, it is possible to overcome these limitations. According to embodiments, a seamless transition experience is provided to users switching between the two types of programs (executed as web service) by linking those with a read/write connection to a common data store.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media. The computer program product may also be a propagated signal on a carrier (e.g. a frequency or phase modulated signal) or medium readable by a computing system and encoding a computer program of instructions for executing a computer process.

Throughout this specification, the term “platform” may be a combination of software and hardware components for providing web based spreadsheet and database services. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network.

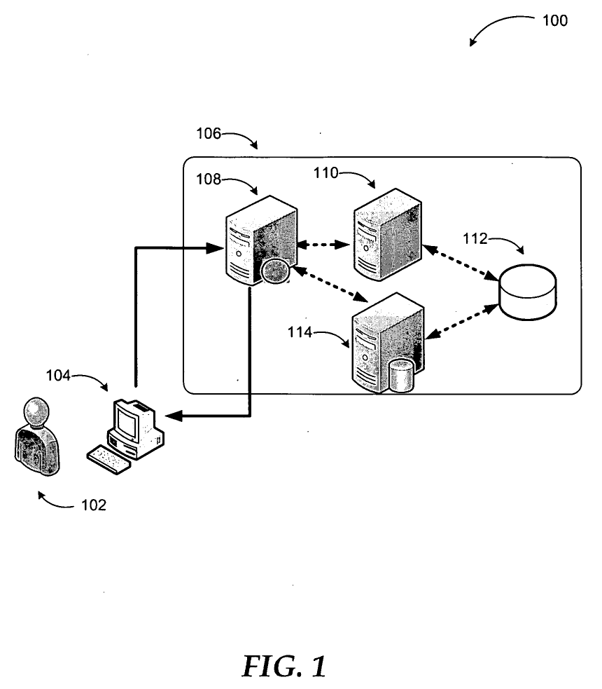

Referring to FIG. 1, conceptual diagram 100 illustrating an example web service providing spreadsheet and database functionality, where embodiments may be implemented, is illustrated. In a system according to embodiments, a database table (datasheet) stored in a common data store with spreadsheet data may be retrieved through a database service query processor by a spreadsheet service front end server and rendered at the user's browser in spreadsheet view. This way, the user is enabled to view, edit, and perform other operations on the database data through spreadsheet user interface without damaging the integrity of the database data. A parallel operation may be performed on spreadsheet data through database service front end server and the user's browser.

In the example system of diagram 100, user 102 accesses spreadsheet and database data/functionality through his/her generic client application (e.g. a browser) on computing device 104. Common functionality web service 106 may include a web server 108 that facilitates communications between the user's browser and front end servers 110 and 114 for spreadsheet and database services, respectively. Both front end servers may retrieve and store data at common data store 112.

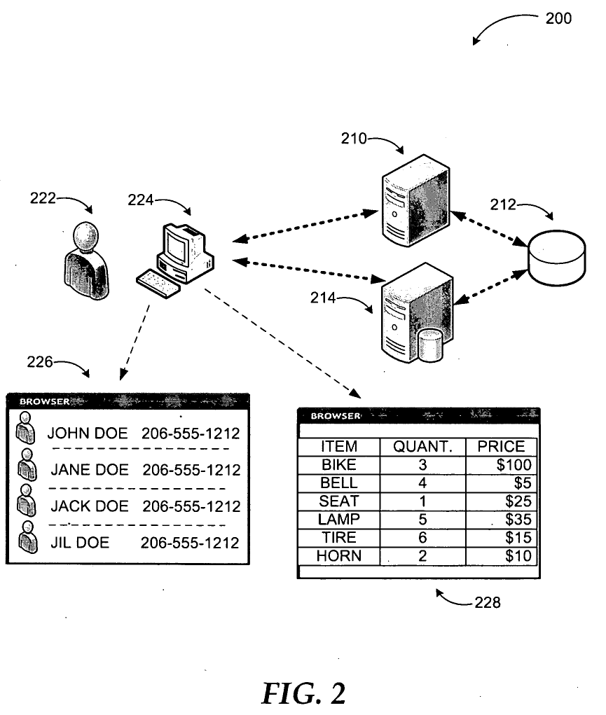

FIG. 2 is a conceptual diagram illustrating another example web service providing spreadsheet and database functionality, where embodiments may be implemented. The system shown in diagram 200 provides similar functionality as in FIG. 1. Differently from diagram 100, however, user 222 accesses spreadsheet tables or database datasheets stored in common data store 212 by directly communicating with front end servers 210 or 214 through their browser executed on computing device 224.

Spreadsheet or database services executed on the front end servers enable rendering of database datasheets as spreadsheet tables (228) or spreadsheet tables as datasheets (226). The integrity of data is maintained by the respective front end server while providing the user the ability to view and edit the data through the companion program's user interface elements.

Components and actions in diagrams 100 and 200 are for illustration purposes only and do not constitute limitation on embodiments. Other components, software or hardware, and configuration may be employed for providing a web based spreadsheet and database service.

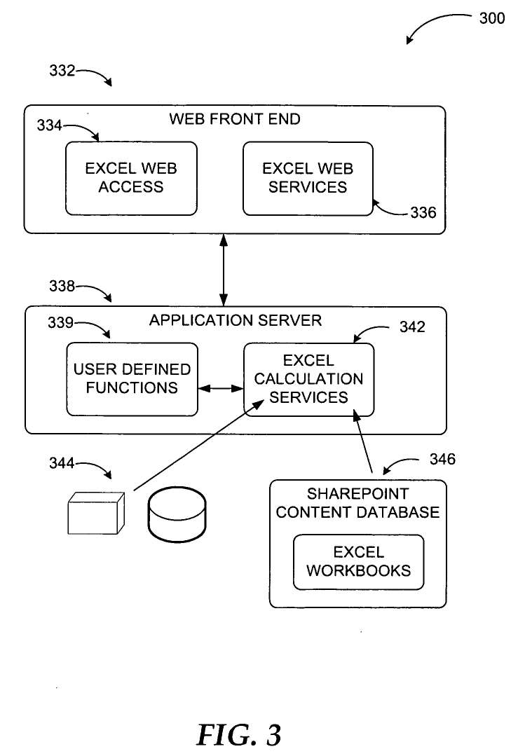

FIG. 3 illustrates architecture of an example spreadsheet service in diagram 300. Microsoft Excel® is a widely used spreadsheet program. Its web service version, Excel Services®, is provided as part of a multi-purpose web service Microsoft Office SharePoint®. Users may create content in their locally installed spreadsheet program and access it via its web service counterpart in via such things as document libraries or dashboards. While Microsoft Excel® and Excel Services® are used to illustrate a spreadsheet based web service in FIG. 3, embodiments are not limited to this particular program or its different versions. Spreadsheet and database coordination through common data store may be implemented with any spreadsheet program, database program, and web service using the principles described herein.

In Excel Services®, end users can view live, interactive spreadsheets using only a web browser. They can also interact with spreadsheets to, for example, explore data, analyze pivot table reports, and generate charts by using their browser. Spreadsheets that are connected to external data sources 344 are supported. There are three core Excel Services® components: Excel Web Access® 334, Excel Web Services® 336, and Excel Calculation Services® 342.

Excel Web Access® 334, Excel Web Services® 336, and Excel Calculation Services® 342 components may be divided into two major groups: the components on a front-end server (“Web front end”) 332 and the component on a back-end application server 338. Excel Web Access® 334 renders live spreadsheets on a web page and allows the user to interact with those spreadsheets. Excel Web Access® 334 is the visible Excel Services® component for the user.

Excel Web Services® 336 is the Excel Services® component that provides programmatic access to its web service. Users can develop applications that call Excel Web Services® 336 to calculate, set, and extract values from spreadsheets, as well as refresh connections to external data sources 344. Using Excel Web Services® 336, users can incorporate server-side spreadsheet logic into an application, automate the updating of spreadsheets and create application-specific user interfaces around server-side spreadsheet calculation.

As discussed above, the web front end 332 includes Excel Web Access® 334 and Excel Web Services® 336. The Excel Calculation Services® 342 component resides on the back-end application server 338, alongside any user-defined function assemblies 339 that can be added by an administrator. According to a basic configuration, all three components may be installed on the same computer. However, in a typical enterprise environment with a large number of users, the components on the web front-end server 332 and the back-end application server 338 may be on different computers in a server farm configuration. Data may be stored and retrieved from external data sources 344 as well as spreadsheets from the web service's own database (346).

Microsoft Access® is a database application with functionality similar to Excel®, but focused on database operations. Comparable to Excel Services®, Microsoft Access® functionality may also be provided as a web service as part of a hosted sharing service. However, users may face a challenge using both programs as part of a service. Particularly, one of the spreadsheet or the database application may have to be limited to a read-only view.

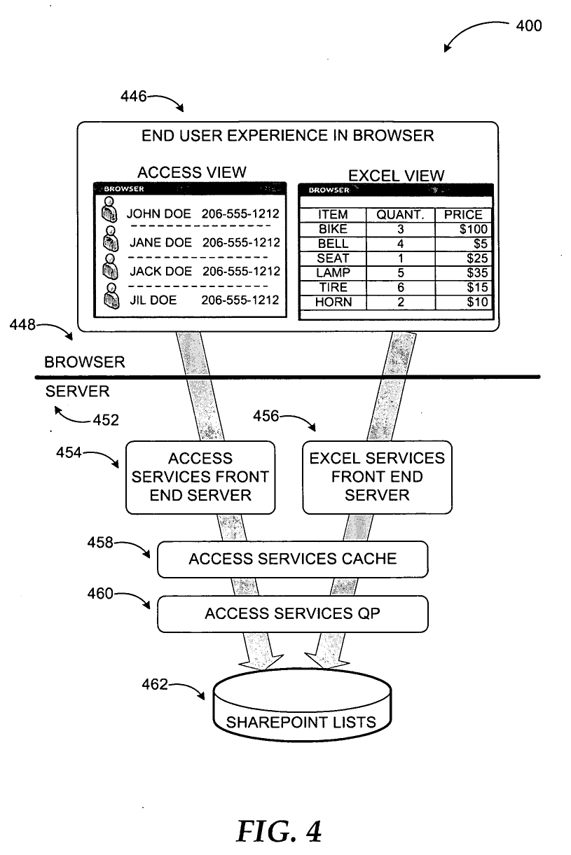

FIG. 4 illustrates an overall architecture of a web service providing spreadsheet and database functionality with a common data store according to embodiments. Embodiments address the above described challenge by coordinating the above mentioned companion services in coordination with a common data store. As mentioned previously, embodiments are not limited to the listed spreadsheet or database applications and may be implemented employing any spreadsheet or database program.

Both spreadsheet and database programs can process data in tables. Thus, a user can view, modify, analyze, and perform other operations on table data using either a spreadsheet program or a database program. In a system according to embodiments, a table within the spreadsheet application (e.g. Excel Services®) and a table within a database application (e.g. Access Services®) are linked with a read/write connection to a common data store (e.g. SharePoint® List 462). Changes made through Excel Services® front end server 456 are reflected in the table rendered through Access Services® front end server 454 and vice versa. It should be noted that front end server 456 is not necessarily the same server providing web front end services (336) described in FIG. 3 as it may be required to also contain Excel Calculation Services 342, or comprise the two machines shown in FIG. 3.

From a user experience perspective (446), browser 448 enables the end user to view the table through spreadsheet view (Excel view) or database view (Access view). The servers (452) of the web service include front end server for Access Services 454 that renders the database view of the table. Excel Services front end server 456 renders the spreadsheet view making the navigation from a traditional database (Access) view to a spreadsheet (Excel) view seamless. The spreadsheet view replaces the traditional database datasheet view. The spreadsheet view may have many advantages over the database datasheet view. For example, editing is more flexible and familiar to the users who are familiar with spreadsheet user experiences. Moreover, users can quickly create calculations or charts of structured data.

Data in table format is retrieved from common data store (e.g. SharePoint® Lists) 462 through Access Services Query Processor 460 and cached at Access Services Cache 458. The strict data integrity that is defined in the database is maintained while the data is edited through the spreadsheet view. Thus, a user may access database data in a spreadsheet application view, edit, and store through the database/spreadsheet combined web service without having to deal with limitations of the database application and converting/reconverting the data between the underlying database and spreadsheet applications. Data integrity is one of the “features” that databases offer over spreadsheets. Two other important ones are: 1) the ability to create forms and reports that provide a variety of vies on data and 2) the ability to join together related lists of data into a single view. Embodiments enable provision of these additional capabilities to users regardless of which service user interface they employ to access the data.

The above discussed user interfaces, scenarios, example systems, applications, and actions are for illustration purposes. Embodiments are not restricted to those examples. Other applications, configurations, and user interfaces may be used in implementing a web based spreadsheet and database service in a similar manner using the principles described herein.

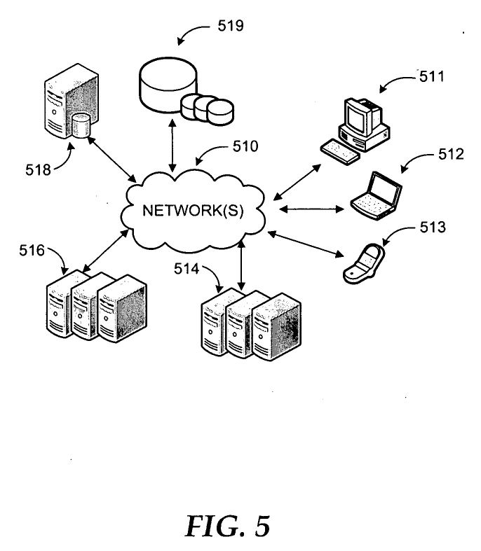

FIG. 5 is an example networked environment, where embodiments may be implemented. A platform providing a web based spreadsheet and database service may be implemented via software executed over one or more servers 514 such as a hosted service. The platform may communicate with client applications (e.g. browsers) on individual computing devices such as a smart phone 513, a laptop computer 512, and desktop computer 511 (client devices) through network(s) 510. In a system according to embodiments, spreadsheet and database front end servers may provide rendering of spreadsheet tables and database datasheets in each other's respective user interfaces to client applications executed on client devices 511-513 or within Internet browsers executed on client devices 511-513. The front end servers providing this essential functionality may be part of server groups 514 or 516 operating as part of the same web service. The backend application servers providing respective functionality may store and retrieve data in one or more common data stores such as data stores 519 directly or through data store management server 518. The front end servers may be scalable independently from the backend application servers enabling the system to grow or shrink depending on client needs and system size.

Network(s) 510 may comprise any topology of servers, clients, Internet service providers, and communication media. A system according to embodiments may have a static or dynamic topology. Network(s) 510 may include a secure network such as an enterprise network, an unsecure network such as a wireless open network, or the Internet. Network(s) 510 may also coordinate communication over other networks such as PSTN or cellular networks. Network(s) 510 provides communication between the nodes described herein. By way of example, and not limitation, network(s) 510 may include wireless media such as acoustic, RF, infrared and other wireless media.

Many other configurations of computing devices, applications, data sources, and data distribution systems may be employed to implement a system for a web based spreadsheet service using asynchronously retrieved grid blocks. Furthermore, the networked environments discussed in FIG. 5 are for illustration purposes only. Embodiments are not limited to the example applications, modules, or processes.

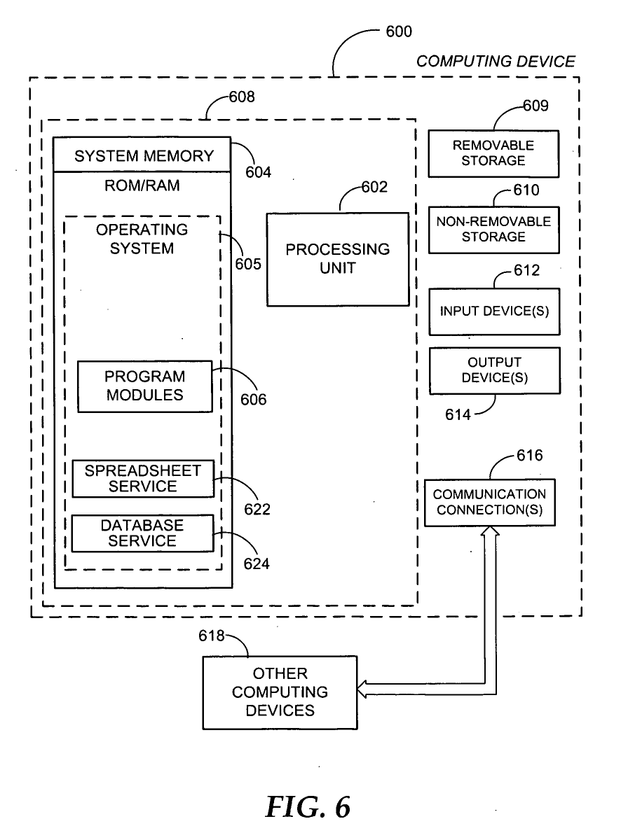

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be a front end server of a hosted service providing spreadsheet and database services to client browsers and include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® operating systems from MICROSOFT CORPORATION of Redmond, Wash. The system memory 604 may also include one or more software applications such as program modules 606, spreadsheet service 622, and database service 624.

Spreadsheet service 622 and database service 624 may be an integral part of a common functionality web service rendering spreadsheet tables and database datasheets in each other's user interface to a client application, thereby, enabling a client to view and edit data in a different environment while maintaining data integrity in a common data store. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 618 may include computer device(s) that execute communication applications, host service servers, and comparable devices. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

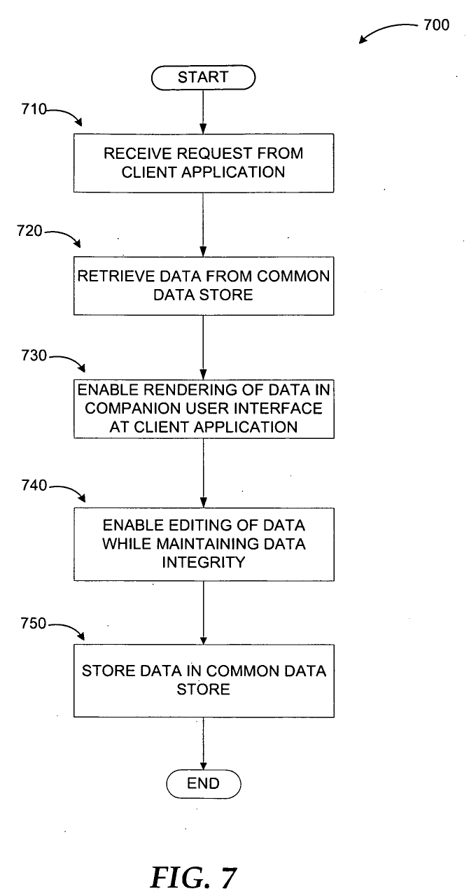

FIG. 7 illustrates a logic flow diagram for process 700 of providing seamless spreadsheet and database views to a user from a web service according to embodiments. Process 700 may be implemented as part of a web service as discussed in FIG. 1 and 2.

Process 700 begins with operation 710, where a request from a client application for rendering a spreadsheet table as database datasheet or vice versa is received. At subsequent operation 720, the data is retrieved from the common data store, where the tables and datasheets are linked through a read/write connection. With the retrieved data, the spreadsheet table is rendered in a database user interface at the client application or the datasheet is rendered in a spreadsheet user interface at operation 730.

At operation 740, the user is enabled to view and edit the data employing the companion user interface. For example, the user may perform spreadsheet calculations, create charts, and perform comparable operations on database data, and vice versa. The data integrity is maintained during the editing of the data. At operation 750, the edited data is stored in the common data store again for future use. According to some embodiments, tables may be auto-generated and syndicated as forms.

The operations included in process 700 are for illustration purposes. A web based spreadsheet/database service may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for rendering spreadsheet data through database user interface and database data through spreadsheet user interface, the method comprising:
receiving a request for rendering database data through a spreadsheet user interface at a web service;
retrieving data from a common data store, wherein spreadsheet tables and database datasheets are linked with a read/write connection to the common data store;
enabling rendering of the database data through the spreadsheet user interface at a requesting user's client application through a web front end service; and
storing edited data at the common data store.

2. The method of claim 1, wherein rendering the database data through the spreadsheet user interface includes enabling the user to view and edit the database data through spreadsheet user interface elements at the user's client application.

3. The method of claim 1, wherein the database data is rendered through the spreadsheet user interface without requiring an installation of a program at the user's client computing device.

4. The method of claim 1, wherein the user is enabled to edit the database data through the spreadsheet user interface while maintaining an integrity of the database data.

5. The method of claim 1, further comprising:
enabling rendering of the spreadsheet data through a database user interface at a requesting user's client application through another web front end service.

6. The method of claim 5, further comprising:
enabling editing of the spreadsheet data through the database user interface at the requesting user's client application through the other web front end service.

7. The method of claim 1, wherein respective web front end services enable the user to navigate seamlessly between a spreadsheet user interface and a database user interface to view and to edit data stored in the common data store.

8. The method of claim 1, wherein the web service is arranged to auto-generate and syndicate forms from retrieved data in table format.

9. A system for providing spreadsheet and database functionality service, the system comprising:
a first web front end (WFE) server configured to:
in response to receiving a request from a browsing application for rendering database data through a spreadsheet user interface, forward the request to a backend server managing the database data at a common data store;
receive requested database data from the backend server; and
provide the database data to the browsing application for rendering through the spreadsheet user interface;
the backend server configured to:
retrieve the database data from the common data store through a query processor; and
forward the requested database data to the first WFE server.

10. The system of claim 9, wherein the backend server is further configured to cache the retrieved database data.

11. The system of claim 9, wherein the first WFE server is further configured to enable the browsing application provide the user options for at least one from a set of: analyzing, modifying, extracting values from, performing calculations on, and generating charts from the database data.

12. The system of claim 9, wherein the first WFE server is further configured to provide the database data to a client application capable of processing the database data employing spreadsheet operations in response to call from the client application.

13. The system of claim 9, wherein the first WFE server is configured to communicate with the browsing application through one of: direct communication and indirect communication facilitated by another web server.

14. The system of claim 9, the system further comprising:
a second web front end (WFE) server configured to:
in response to receiving a request from the browsing application for rendering spreadsheet data through a database user interface, forward the request to the backend server managing the database data at the common data store;
receive requested spreadsheet data from the backend server; and
provide the spreadsheet data to the browsing application for rendering through the database user interface.

15. The system of claim 14, wherein the first and second WFE servers are scalable independently from the backend server.

16. The system of claim 14, wherein the first WFE server, the second WFE server, and the backend server are part of a hosted sharing service maintaining user documents and enabling spreadsheet and database functionality on the maintained documents.

17. A computer-readable storage medium with instructions stored thereon for providing spreadsheet and database related web services, the instructions comprising:
receiving a request for rendering one of: spreadsheet data through a database user interface and database data through a spreadsheet user interface;
forwarding the request to one of a spreadsheet services front end server and a database services front end server;
forwarding the request from the one of the spreadsheet services front end server and the database services front end server to a backend server for retrieval and processing;
retrieving data from a common data store, wherein spreadsheet data and database data are linked with a read/write connection to the common data store; and
forwarding the retrieved data through the one of the spreadsheet services front end server and the database services front end server to a backend server to a requesting client application for rendering.

18. The computer-readable medium of claim 17, wherein the instructions further comprise:
enabling a user to view and edit the requested spreadsheet data through the database user interface and database data through the spreadsheet user interface, wherein a navigation between the user interfaces is seamless.

19. The computer-readable medium of claim 18, wherein the user is enabled to share the one of the database data and the spreadsheet data with other users of a web service managing the common data store.

20. The computer-readable medium of claim 17, wherein the data is table format.
